(19) United States
(12) Patent Application Publication
(10) Pub. No.: US 2004/0017733 A1
(43) Pub. Date: Jan. 29, 2004

(54) Custom designed virtual time piece

(76) Inventor: Brian E. Sullivan, Alta Loma, CA (US)

Correspondence Address: SHELDON & MAK, 225 South Lake Avenue, 9th Floor, Pasadena, CA, 91101, US

(21) Appl. No.: 10/205,047

(22) Filed: Jul. 24, 2002

(51) Int. Cl. G04C 19/00

(52) U.S. Cl. 368/82

(57) ABSTRACT

A custom designed and personalized virtual time piece comprises the image of a case, the image of a face, a time keeping mechanism, the image of an hour hand spindle and the image of a minute hand spindle. A personal photographic image provided by a customer is divided into a torso and head portion, a first appendage portion and a second appendage portion. The image of the second appendage portion provides the hour hand of the virtual time piece and the image of the first appendage portion provides the minute hand of the time piece. The torso and head portion appears to be disposed between the hour hand and the minute hand.

### FIELD OF THE INVENTION

This invention relates generally to virtual time pieces, such as virtual clocks and, more specifically to virtual time pieces having the persona of a person or other animal illustrated therein.

### BACKGROUND OF THE INVENTION

Time pieces, such as watches and clocks having images of cartoon characters, real people or other animal illustrated therein, have been popular for many years. The images illustrated in such time pieces are, for the most part, images chosen by the time piece manufacturer.

Recently, some purveyors of time pieces have also offered the buying customer a choice of background illustrations disposed on the face portion of the time piece. In most cases, the customer chooses a background illustration from a set of pre-prepared background illustrations. In some cases, however, a photograph provided by the customer has been appended to the face portion of the time piece, thereby personalizing the time piece of the customer. Unfortunately, such personalized time pieces are totally static, the hour hand and the minute hand of such time pieces being not personalized in any way.

Accordingly, time pieces having images are either wholly chosen by the manufacturer or wholly static. In co-pending patent application Ser. No. ______, filed Jun. 14, 2002, a personalized time piece was disclosed which can be custom designed by the end customer.

Virtual time pieces, such as clocks displayed on computer monitor screens, are also known. However, there appears to be a need for a virtual time piece which too can be custom designed by the end customer.

### SUMMARY

The invention satisfies this need. In one embodiment, the invention is a method of custom designing and creating an individual virtual time piece. The method comprises the steps of (a) providing first computer readable program code for causing a computer to display a time piece having a face, the first computer readable program code being capable of keeping time, (b) identifying from a specific customer for the time piece a specific subject of the animal family whose image is desired to be used in the custom design of the face and hands of the time piece, (c) obtaining from the customer, or obtaining for the customer, at least one photographic image of the subject of the animal family identified in step (b), (d) digitally separating the at least one photographic image attained in step (c) into a digital image of a torso and head portion, a digital image of a first appendage portion and a digital image of a second appendage portion, and (e) providing second computer readable program code for causing a computer to display a composite of the digital images of the torso and head portion, the first appendage portion, the second appendage portion and the time piece face, so as to create a digital image of the specific subject of the animal family on the face, such that the images of the first appendage portion and the second appendage portion appear to be attached to the torso and head portion in an anatomically correct configuration and such that the first appendage portion provides a minute hand of the virtual time piece and the second appendage portion provides an hour hand of the virtual time piece.

In a second embodiment, the invention is a computer readable medium containing instructions for causing a computer to display an individual virtual time piece designed and created by the method described above.

In a third embodiment, the invention is a computer data signal embodied in a carrier wave comprising instructions for causing a computer to display an individual virtual time piece designed and created by the method described above.

In a fourth embodiment, the invention is a custom designed virtual time piece comprising (a) the image of a case, (b) the image of a face, and (c) a time keeping mechanism comprising the image of concentrically disposed minute and hour hand spindles, wherein a multiple layer image of an animal comprising the appearance of at least three layers appears to be disposed above the image of the face, wherein the image of the animal has a torso and head portion, a first appendage portion and a second appendage portion, and wherein the second appendage portion appears to be disposed in a first layer proximate to the image of the face, the torso and head portion appears to be disposed in a second layer proximate to the first layer and the first appendage appears to be disposed in a third layer proximate to the second layer, the second layer appearing to be sandwiched between the first layer and the third layer.

In a fifth embodiment, the invention is a system for selling custom designed virtual time pieces comprising (a) a computer for (i) receiving and storing in digital form one or more photographs of an animal designated by a customer, and for (ii) digitally altering and parsing the one or more photographs to yield a torso and head portion, a first appendage portion and a second appendage portion, (b) a first computer readable program code for causing a computer to display a time piece having a face, a first computer readable program code being capable of keeping time, and (c) a second computer readable program code for causing a computer to display a composite of the digital images of the torso and head portion, the first appendage portion, the second appendage portion, and the time piece face, so as to create a digital image of the specific subject of the animal family on the face, such that the images of the first appendage portion and the second appendage portion appear to be attached to the torso and head portion in an anatomically correct configuration and such that the first appendage portion provides a minute hand of the time piece and the second appendage portion provides an hour hand of the time piece.

### DRAWINGS

These features, aspects and advantages of the present invention will become better understood with regard to the following description, appended claims and accompanying figures where:

FIG. 1 is a plan view of a virtual time piece having features of the invention;

FIG. 2 is a plan view of a first photograph useful in the construction of the virtual time piece illustrated in FIG. 1;

FIG. 3 is a second photograph useful in the construction of the virtual time piece illustrated in FIG. 1;

FIG. 4 illustrates how the photographs illustrated in FIGS. 2 and 3 are parsed to yield manufacturing components for the virtual time piece illustrated in FIG. 1; and

FIG. 5 is a schematic view of a system having features of the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

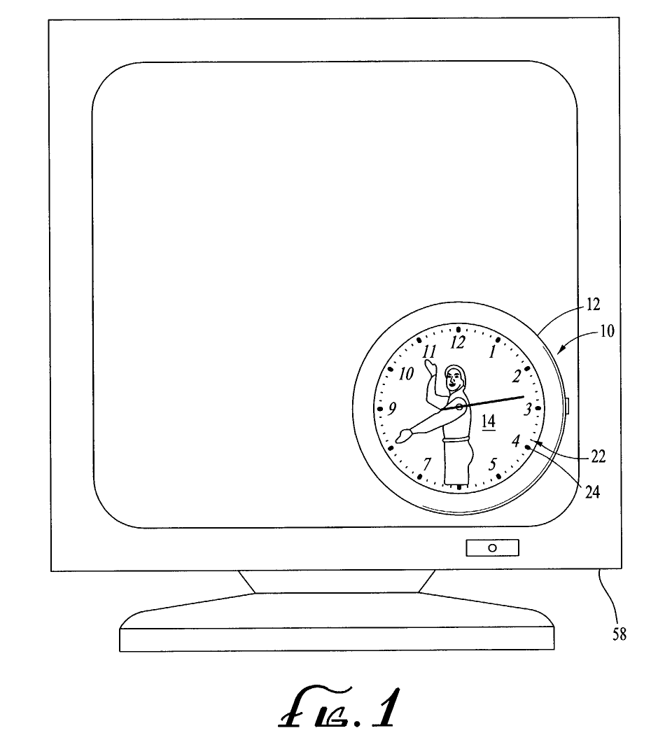

In one embodiment, the invention is a method of custom designing and manufacturing an individual virtual time piece 10, such as illustrated in FIG. 1. The method comprises the five steps described below.

In the first step, a first computer readable program code 11 is provided for causing a computer to display a virtual time piece having the image of a face 14, and, optionally, the image of a case 12. In the embodiment illustrated in FIG. 1, the image of the time piece 10 has the images of a case 12, a face 14, a minute hand spindle 18 and an hour hand spindle 20.

The first computer readable program code 11 is also capable of keeping time.

The image of the case 12 can be an image of any of the myriad of time piece cases known in the art, including clock cases and watch cases. In the embodiment illustrated in FIG. 1, the image of the case 12 is a clock case and the image of the time piece is a clock.

The image of the face 14 can be an image of any typical time piece face of the traditional analog style. The image of the face 14 typically has a dial 22 with a plurality of hour indication marks 24 disposed in a continuous loop, traditionally a circle. The image of the minute hand spindle 18 and the image of the hour hand spindle 20 are concentrically disposed proximate to the center of the image of the face 14.

The second step in the method of the invention is to identify from a specific customer for the time piece 10 a specific subject of the animal family whose image is desired to be used in the custom design of the face 14 and hands 26 of the virtual time piece 10.

The subject of the animal family is typically a human being. The subject can be the customer himself (or herself) or it can be another. Such another is typically a loved one or a famous personage held in esteem by the customer. The subject can also be a non-human subject, for example, a pet of the customer such as a dog or cat. The invention is not restricted to any particular species of the animal family, and is not restricted to mammals.

The third step in the method of the invention is to obtain from the customer, or to obtain for the customer, at least one photographic image 28 of the subject of the animal family identified in the second step. In a typical application of the method, the customer provides the at least one photographic image 28. However, if the customer does not have the at least one photographic image 28 but can provide the subject itself, the subject can be photographed by the practitioner of the method to provide the at least one photographic image 28.

The customer can interact with the practitioner of the method in any of a wide varieties of ways, such as in person, via telephone, via the mail or via the Internet. In one application of the invention, the customer interacts with the practitioner of the method via the Internet by providing a Website on the Internet which offers instructions regarding how to take the one or more photographs, how to mail them to the practitioner of the method or how to upload them to the Website server 30 and how to order and pay for the custom designed time piece.

The customer can also provide the practitioner of the method with a hard copy of the at least one photographic image 28 to be used in the virtual time piece 10. The practitioner of the method then digitally scans the at least one photographic image 28 to provide a digital representation of the photograph, and then the practitioner loads that digital representation into a computer 32 for further processing as discussed below.

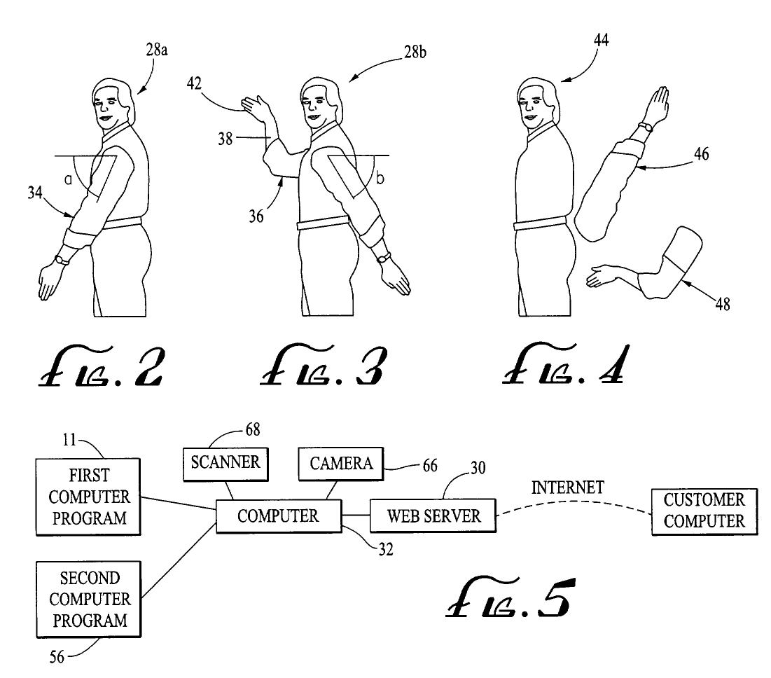

In a preferred embodiment illustrated in FIGS. 2 and 3, the at least one photographic image 28 comprises two photographic images, a first photographic image 28a and a second photographic image 28b. The first photographic image 28a can be a side view of a human being taken with a camera lens disposed approximately at the same level as the subject shoulder. In this first photographic image 28a, one arm 34 of the subject is shown in the foreground which is extended forwardly straight and declined from the horizontal at a first angle of declination α of between about 30° and about 60°. The second photographic image 28b is preferably the same side view as the first photographic image 28a except that the arm 34 shown in the foreground is extended straight rearwardly and declined from the horizontal at a second angle of declination β between about 45° and about 80°, and the second arm 36 of the human being is shown in the background disposed approximately horizontal with the forearm portion 38 being disposed approximately vertically and, more preferably, with the palm of the hand 42 being disposed upwardly.

The fourth step in the method of the invention is to separate the at least one photographic image 28 obtained in the third step into a torso and head portion 44, a first appendage portion 46 and a second appendage portion 48. This step is illustrated in FIG. 4. Typically, this step is accomplished with a computer 32 using one of the many computer programs for altering photographic images. One such computer program is PHOTOSHOP® sold by Adobe Systems, Inc. of San Jose, Calif.

In a typical embodiment, where the subject is a human being the first appendage portion 46 is one of the two arms or two legs of the human being and the second appendage portion 48 is the other of the two arms or legs of the human being. In embodiments of the invention where the subject is an animal other than a human being, the first appendage portion 46 can be a first leg and the second appendage portion 48 can be a second leg. In other embodiments, other appendages of the subject matter animal can be used, such as a tail, a wing, a flipper, etc.

The fifth step of the method of the invention is to provide a second computer readable program code 56 for causing a computer 32 to display a composite of the digital images of the torso and head portion 44, the first appendage portion 46, the second appendage portion 48 and the time piece face 14 so as to create a composite digital image of the specific subject of the animal family and the face 14, such that the images of the first appendage portion 46 and the second appendage portion 48 appear to be attached to the image of the torso and head portion 44 in an anatomically correct configuration and such that the image of the first appendage portion 46 provides a minute hand 26b for the virtual time piece 10 and the image of the second appendage portion 48 provides an hour hand 26a for the virtual time piece 10.

The image of the minute hand 26b is typically displayed so as to appear to be disposed above the image of the torso and head portion 44, such that the image of the torso and head portion 44 appears to be sandwiched between the images of the hour hand 26a and the minute hand 26b. The resulting composite image is an apparent three-layer image of the subject having the appearance of being disposed above the image of the face 14.

The method can further comprise the step of incorporating into the image of the face 14 a background photographic image (not shown).

The method can also further comprise the step of associating the image of a second hand 26c or a second indicating disk (not shown) with the image of the second hand spindle 40 on the virtual time piece 10.

The invention is also a computer readable medium containing instructions for causing a computer of an end user to display on a computer monitor 58 or other computer display device the individual virtual time piece 10 designed and created using the method described above.

The invention is also a computer data signal embodied in a carrier wave comprising instructions for causing a computer to display the individual virtual time piece 10 designed and created by the above described method.

The invention is also the virtual time piece 10, such as is illustrated in FIG. 1. The virtual time piece 10 is a unique custom virtual time piece with the image of an anatomically correct subject having the appearance of being disposed with the unique three-layer (i.e., three dimensional) look.

The invention is also a system 60 for selling custom designed virtual time pieces 10. As illustrated in FIG. 5, the system 60 comprises a computer 32 for (i) receiving and storing in digital form one or more photographs of an animal designated by a customer, and for (ii) digitally altering and parcing the one or more photographs to yield a torso and head portion 44, a first appendage portion 46 and a second appendage portion 48. The system 60 further comprises (iii) a first computer readable program code 11 for causing a computer to display a virtual time piece 10 having the image of a face 14, the first computer readable program code 11 being capable of keeping time, and (iv) a second computer readable program code 56 for causing a computer to display a composite of the digital images of the torso and head portion 44, the first appendage portion 46, the second appendage portion 48 and the time piece face 14 so as to create a digital image of the specific subject of the animal family and the face 14, such that the images of the first appendage portion 46 and the second appendage portion 48 appear to be attached to the torso and head portion 44 in an anatomically correct configuration and such that the first appendage portion 46 provides a minute hand 26b for the virtual time piece 10 and the second appendage portion 48 provides an hour hand 26a for the virtual time piece 10.

The system 60 of the invention can be used to create a custom designed virtual time piece 10 wherein the image of the torso and head portion 44 appears to be disposed to the image of the face 14, the image of the first appendage portion 46 appears to be disposed to the image of the minute hand spindle 18 and the image of the second appendage portion 48 appears to be disposed to the image of the hour hand spindle 20.

The system can further comprise a digital camera 66 for taking one or more photographs of the animal designated by the customer.

The system can also further comprise a digital scanner 68 for scanning one or more photographs provided by the customer to provide the one or more photographic images 28 in digital form for input into the computer 32.

The system can further comprise a server 30 adapted to host a Website, the Website comprising instructions regarding how to take the one or more photographs, how to upload those photographs to the server, and how to order and pay for the custom designed time piece 10.

The invention provides an efficient system and method for creating an inexpensive, totally individual, custom-made virtual time piece having a unique three-dimensional appearance. Although the virtual time piece is totally individualized by the customer, the virtual time piece can be efficiently created using the method and the system by a wide variety of customer contact methods, including face-to-face contact, telephone contact, regular mail contact, e-mail contact and contact via an Internet Website.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A method of custom designing and creating an individual virtual time piece having images of a face, an hour hand and a minute hand, the method comprising the steps of:
(a) providing first computer readable program code for causing a computer to display a time piece having a face, the first computer readable program code being capable of keeping time;
(b) identifying from a specific customer for the time piece a specific subject of the animal family whose image is desired to be used in the custom design of the images of the face and hands of the time piece;
(c) obtaining from the customer, or obtaining for the customer, at least one photographic image of the subject of the animal family identified in step (b);
(d) digitally separating the at least one photographic image attained in step (c) into a digital image of a torso and head portion, a digital image of a first appendage portion and a digital image of a second appendage portion; and
(e) providing second computer readable program code for causing a computer to display a composite of the digital images of the torso and head portion, the first appendage portion, the second appendage portion and the time piece face, so as to create a digital image of the specific subject of the animal family on the image of the face, such that the images of the first appendage portion and the second appendage portion appear to be attached to the torso and head portion in an anatomically correct configuration and such that the first appendage portion provides a minute hand for the virtual time piece and the second appendage portion provides an hour hand for the virtual time piece.

2. The method of claim 1 wherein the subject of the animal family is a human being and wherein the first appendage portion depicts one arm of the human being and the second appendage portion depicts the second arm of the human being.

3. The method of claim 2 wherein the at least one photographic image obtained in step (c) of claim 1 is a side view of a human being showing one arm in the foreground and one arm in the background, the arm in the foreground being extended straight and the arm in the background being cocked at the elbow at an angle of between about 45° and about 170°.

4. The method of claim 2 wherein the at least one photographic image comprises two photographic images, (i) a first photographic image which is a side view of a human being showing one arm in the foreground, the arm in the foreground being extended forwardly straight and declined from the horizontal at a first angle of declination of between about 30° and about 60°, and (ii) a second photographic image which is the same side view as depicted in the first photographic image, except that one arm, shown in the foreground, is extended straight rearwardly and declined from the horizontal at a second angle of declination between about 45° and about 80° and a second arm, shown in the background, has an upper arm which is disposed approximately horizontally and a forearm which is disposed approximately vertically, the palm of the hand on the second arm being disposed upwardly.

5. The method of claim 4 wherein the first appendage portion is the arm in the foreground of the first photographic image and the second appendage is the arm in the background in the second photographic image.

6. The method of claim 1 wherein the step of obtaining at least one photographic image comprises the step of taking a photograph of an animal requested by the customer.

7. The method of claim 1 wherein the images of the torso and head portion, the first appendage portion and the second appendage portion are disposed proximate to one another to form a multiple layer image, the multiple layer image having the appearance of being comprised of at least three layers and of being disposed in front of the image of the face, the hour hand having the appearance of being disposed within a first layer, the torso and head portion having the appearance of being disposed within a second layer and the minute hand having the appearance of being disposed within a third layer, the second layer having the appearance of being sandwiched between the first layer and the third layer.

8. A computer readable medium containing instructions for causing a computer to display an individual virtual time piece designed and created using the method of claim 1.

9. A computer data signal embodied in a carrier wave comprising instructions for causing a computer to display an individual virtual time piece designed and created using the method of claim 1.

10. A custom designed virtual time piece comprising:
(a) the image of a case;
(b) the image of a face; and
(c) a time keeping mechanism comprising the images of concentrically disposed minute and hour hand spindles;
wherein a multiple layer image of an animal comprising the appearance of at least three layers appears to be disposed above the image of the face;
wherein the image of the animal has a torso and head portion, a first appendage portion and a second appendage portion; and
wherein the second appendage portion appears to be disposed in a first layer proximate to the image of the face, the torso and head portion appears to be disposed in a second layer proximate to the first layer and the first appendage appears to be disposed in a third layer proximate to the second layer, the second layer appearing to be sandwiched between the first layer and the third layer.

11. The custom designed virtual time piece of claim 10 wherein the first appendage portion and the second appendage portion appear to be disposed proximate to the torso and head portion such that they appear to be anatomically correct with respect to the torso and head portion.

12. A custom designed virtual time piece comprising:
(a) an image of a case;
(b) an image of a face; and
(c) a time keeping mechanism comprising the images of concentrically disposed minute and hour hand spindles;
wherein the image of the face comprises a side view image of a human being, the side view image appearing to be disposed on the image of the face such that the images of the hour hand spindle and the minute hand spindle appear to be disposed through the shoulder of the human being in the side view image;
wherein the image of the minute hand depicts a first arm of the human being shown in an extended and straight orientation; and
wherein the image of the hour hand depicts a second arm of the human being, the second arm being depicted in a cocked position and wherein the forearm is cocked at the elbow at an angle less than 180°.

13. The custom designed virtual time piece of claim 12 wherein the image of the hour hand appears to be disposed between the image of the face and the side view image and the side view image appears to be disposed between the images of the hour hand and the minute hand.

14. The custom designed time piece of claim 12 wherein the forearm is cocked at the elbow at an angle between about 45° and 170°.

15. The custom designed virtual time piece of claim 12 wherein the side view image, the first arm and the second arm appear to be disposed proximate to one another to form a multiple layer image, the multiple layer image appearing to be comprised of at least three layers and appearing to be disposed in front of the image of the face, the image of the hour hand appearing to be disposed in a first layer proximate to the image of the face, the side view image appearing to be disposed in a second layer and the image of the minute hand appearing to be disposed in a third layer, the second layer appearing to be sandwiched between the first layer and the second layer.

16. A system for selling custom designed virtual time pieces comprising:
(a) a computer for (i) receiving and storing in digital form one or more photographs of an animal designated by a customer, and for (ii) digitally altering and parsing the one or more photographs to yield a torso and head portion, a first appendage portion and a second appendage portion;
(b) a first computer readable program code for causing a computer to display a virtual time piece having the image of a face, the first computer readable program code being capable of keeping time; and
(c) a second computer readable program code for causing a computer to display a composite of the digital images of the torso and head portion, the first appendage portion, the second appendage portion and the time piece face, so as to create a digital image of the specific subject of the animal family on the face, such that the images of the first appendage portion and the second appendage portion appear to be attached to the torso and head portion in an anatomically correct configuration and such that the first appendage portion provides a minute hand for the virtual time piece and the second appendage portion provides an hour hand for the virtual time piece.

17. The system of claim 16 further comprising a digital camera for taking the one or more photographs of an animal designated by the customer.

18. The system of claim 16 further comprising a digital scanner for scanning one or more photographs provided by the customer to provide the one or more photographs in digital form for input into the computer.

19. The system of claim 16 further comprising a server adapted to host a Website, the Website comprising instructions regarding how to take the one or more photographs, how to upload those photographs to the server and how to order and pay for the custom designed time piece.
